(19) United States
(12) Patent Application Publication
(10) Pub. No.: US 2025/0135834 A1
(43) Pub. Date: May 1, 2025

(54) HEAT EXCHANGER ASSEMBLY IN A MOTOR VEHICLE

(71) Applicant: MAHLE INTERNATIONAL GMBH, Stuttgart (DE)

(72) Inventors: Arnaud BOULLIN, Ingersheim (DE); Reinhard HEINE, Leutenbach (DE)

(21) Appl. No.: 18/924,037

(22) Filed: Oct. 23, 2024

(30) Foreign Application Priority Data
Oct. 27, 2023 (DE) 102023129755.4

(51) Int. Cl. B60H 1/00

(52) U.S. Cl. CPC B60H 1/00328

(57) ABSTRACT

A heat exchanger assembly for transferring heat between a liquid and air is provided.

The heat exchanger assembly includes
a frame with at least one fan,
the frame has two parallel side pieces, each of which has a groove into which a heat exchanger can be inserted,
the heat exchanger is substantially perpendicular to the air flow passing through it, generated by the fan in the assembled state,
the heat exchanger can be inserted into the groove such that a seal is obtained, and air leakage through the groove is at least minimized,
the heat exchanger and fan are substantially parallel to one another in the assembled state,
the at least two heat exchangers can be inserted into the grooves from above or below.

### CROSS REFERENCE TO RELATED APPLICATIONS

This application claims priority from German Patent Application No. DE 2023 129 755.4, filed on Oct. 27, 2023, the entirety of which is hereby incorporated by reference herein.

The present invention relates to a heat exchanger assembly with which heat is exchanged between two fluids, in particular a liquid and air, as set forth in claim 1. The invention also relates to a motor vehicle that has such a heat exchanger assembly.

This type of heat is exchanger assembly, with which heat is exchanged between two fluids, in particular a liquid and air, is disclosed in DE 198 31 256 A1. This heat exchanger assembly contains a mount with a frame into which at least one heat exchanger can be inserted. The frame is composed of two parallel side pieces, and two parallel connecting end pieces, with at least one slot formed in each of the side pieces, into which the heat exchangers can be inserted in the manner of a drawer. The two side pieces and two end pieces form an air conducting intake frame through which air passes from the heat exchanger to an air intake.

A frame is disclosed in DE 10 2018 214 283 B3 for a fan module for a radiator and an intercooler in a motor vehicle. The radiator is contained in a main frame, while the intercooler is contained in a separate frame. There is a seal between the main frame and the second frame. This is intended to prevent air leakage.

A module frame for various heat exchangers in a motor vehicle engine that has a support frame intended for use in the automotive industry is disclosed in DE 100 61 561 A1, which has a bottom and two perpendicular side pieces with slots opening toward one side into which at least one coolant cooler or air cooler and one air conditioner condenser can be inserted. There is also an end piece that secures the heat exchangers inserted into the frame in place, forming a robust support connecting the side pieces to the support frame, which has mounts for an oil cooler. This is intended to be used as a simple module frame.

In modern motor vehicles, in particular internal combustion engine vehicles, but also hybrid and electric vehicles, heat exchanger assemblies are used that are often composed of numerous individual components, which are not only difficult to assemble, but are also expensive to store and ship. It is also difficult, and therefore expensive, to replace individual heat exchangers in these assemblies.

The present invention therefore addresses the problem of creating a better, or at least alternative, design for this type of heat exchanger assembly, which is easy to maintain and repair, as well as assemble.

This problem is solved by the invention with the subject matter of independent claim 1. Advantageous embodiments are the subject matter of the dependent claims.

The present invention is based on the general concept of designing a heat exchanger assembly with an extremely small number of parts that can also be easily assembled, which has at a frame containing at least one fan, and also has grooves for a heat exchanger. The heat exchanger can be inserted into the grooves in the manner of a drawer, in particular from above, thus significantly simplifying assembly, as well as maintenance and repairs requiring replacement of the heat exchanger. Because the heat exchanger can be slid into the grooves, in particular from above, it requires relatively little installation space. By integrating at least one fan in the frame, no other parts are needed to secure the fan to the heat exchanger assembly, thus reducing the number of parts and reducing storage and shipping, as well as assembly costs. The heat exchanger assembly obtained with the invention, which is designed for transferring heat between two separate fluids, in particular a liquid and air, contains the aforementioned frame for at least one fan, preferably two adjacent fans, which has two parallel side pieces, each of which has a groove formed in it for a heat exchanger that can be inserted therein from above. In concrete terms, this means that the heat exchanger can preferably be inserted from above in to the substantially vertical grooves. The heat exchanger is substantially upright in the assembled state, and air from the at least one fan flows through it substantially horizontally. The heat exchanger can be inserted into the grooves such that a seal is formed, which at least minimizes air leakage, preferably preventing any leakage whatsoever. The grooves therefore form the aforementioned seal when the heat exchanger is inserted therein, which at least minimizes air leakage, thus ensuring a more effective heat exchange. Of particular advantage is that the heat exchanger assembly obtained with the invention has a simple structure, specifically composed of the frame for the at least one fan and the heat exchanger inserted into the grooves. There is therefore no need for other parts, in particular for securing the heat exchanger to the frame, e.g. threaded fasteners. Moreover, maintenance and repairs are significantly simplified, in that the heat exchanger can be inserted into the grooves in the frame, or removed therefrom, from above.

In general, “substantially parallel,” “substantially perpendicular”, “substantially horizontal or vertical” always allows for a deviation of ±10°.

In an advantageous embodiment of the heat exchanger obtained with the invention, the heat exchanger and at least one fan are substantially parallel in the assembled state. This allows the air from the fan to flow through the heat exchanger with little or no significant resistance. The frame can preferably contain two fans. If more heat needs to be exchanged between the air and the liquid, it is possible to increase the amount of air flowing through the heat exchanger by using more fans.

In an advantageous embodiment of the heat exchanger assembly obtained with the invention, the frame has two substantially upright parallel side pieces. The side pieces each have at least two grooves into which heat exchangers can be inserted from above or below. In concrete terms, this means that the heat exchangers can be inserted into the substantially vertical grooves from above or below. The at least two heat exchangers can be substantially parallel and upright, such that the air from the at least one fan flows through them substantially horizontally. This also means that the heat exchangers can be tilted ±10° in relation to one another or the at least one fan, due to the alignment of the grooves. The at least two heat exchangers can be inserted into the grooves such that a seal is formed that at least minimizes, preferably prevents, air leakage. The two preferably parallel and adjacent grooves thus form the aforementioned seal when the heat exchangers are inserted therein, at least minimizing air leakage and resulting in a more effective heat exchange in the heat exchanger assembly. Undesired leakage would reduce the air flowing through the heat exchangers, therefore also reducing the heat exchange between the liquid and air.

In an advantageous embodiment of the heat exchanger assembly obtained with the invention, the frame for the fans is made of injection molded plastic. Ideally, the frame is made of a single piece of injection molded plastic, resulting in both a better and less expensive production. Because it is a single piece, the frame does not need to be assembled, thus reducing assembly costs. The at least one fan can be attached to the frame with threaded fasteners or using other connectors, e.g. snap-together connectors or clamps.

In a particularly preferred embodiment of the heat exchanger obtained with the invention, there is a catch that is integrally formed in at least one of the side pieces, which engages in a counterpart on the heat exchanger when it is inserted into the groove, thus securing the heat exchanger in place. It is substantially secured vertically, in particular. There can be a stop at the lower ends of the grooves, or a crosspiece, which prevents the heat exchangers from falling out. Because the catch is an integral part of the side piece, or the frame, it is relatively simple to secure the heat exchangers in the frame, in particular without any additional parts such as threaded fasteners. It is also easy to remove the heat exchangers from the grooves without additional tools, by simply releasing the catch and pulling the heat exchangers out of the grooves.

In another advantageous embodiment of the heat exchanger assembly obtained with the invention, fastening contours are integrally formed on the frame for attaching the heat exchanger assembly to a vehicle body. The frame therefore allows the heat exchangers to be installed easily in a form-fitting and sealing manner, and they can also be easily mounted on a vehicle body, with corresponding attachment points or contours, e.g. holes, that are integrally formed in the frame. These attachment contours can be formed during the injection molding process.

Ideally, the heat exchangers fit in the grooves without forming gaps, or with gaps of between 0.5 mm and 1.0 mm. This results in a tight seal, with very little, or no, air leakage, thus improving the performance of the heat exchanger assembly.

In another advantageous embodiment obtained with the invention, a sealing contour is formed on the frame that seals the groove. This contour can be formed by a flexible double lip, or relatively stiff fin. This further seals the heat exchangers in their grooves, further reducing any air leakage. The sealing contour can be made of plastic for example, formed during the injection molding process.

In another embodiment, at least one heat exchanger has reservoirs on each side, which are inserted into the grooves in the frame. These reservoirs thus form part of the seal and can be connected at the top or bottom to a coolant circuit. The connection is preferably formed at the top because this makes it easier to access for maintenance and repairs. A coolant circuit is a system with which a component that heats up can be cooled. This can be an at least partially electronic drive for a motor vehicle.

In another advantageous embodiment of the heat exchanger assembly obtained with the invention, at least one of the heat exchangers is a coolant cooler, a condenser, or an oil cooler. This incomplete list is an indication of the multifaceted possibilities for embodiments of the heat exchangers. Theoretically, it is even conceivable that at least one of the heat exchangers does not extend over the entire length of the grooves, such that two heat exchangers can be inserted into these grooves.

In another advantageous embodiment of the heat exchanger assembly obtained with the invention, a diffusor is slid onto the at least one heat exchanger. This results in a force-fitting connection. The diffusor is slid vertically onto the at least one heat exchanger, and installed from the front. This allows the diffusor to be removed substantially from above or below, without requiring lateral installation space. Air is supplied to the at least one heat exchanger by the diffusor. The diffusor is used to direct the air flowing over the vehicle body. It can also adjust the flow of air to the at least one heat exchanger. Because the diffusor can slow the air flow and increase the air pressure, kinetic energy can be converted to pressure. A diffusor is basically a reverse nozzle.

The present invention is also based on the general concept of equipping a motor vehicle, in particular an electric or hybrid vehicle, with the heat exchanger assembly described above, such that the advantages obtained therewith can also be obtained for the motor vehicle. These advantages include a simplified assembly that can be easily maintained, with extremely effective heat exchange, thus also resulting in a more efficient motor vehicle.

Other important features and advantages of the invention can be derived from the dependent claims, drawings, and the descriptions of the drawings.

It is understood that the features specified above and explained below can be used not only in the given combinations, but also in other combinations or in and of themselves, without abandoning the framework of the invention defined by the claims. Components of a superordinate unit specified above and below, e.g. a separate device, apparatus or assembly, can form separate elements or components of this unit or integral parts or sections thereof, even if the drawings indicate otherwise.

Preferred exemplary embodiments of the invention are shown in the drawings and shall be explained in greater detail below, in which the same reference symbols refer to identical, similar, or functionally similar components.

Therein, schematically:

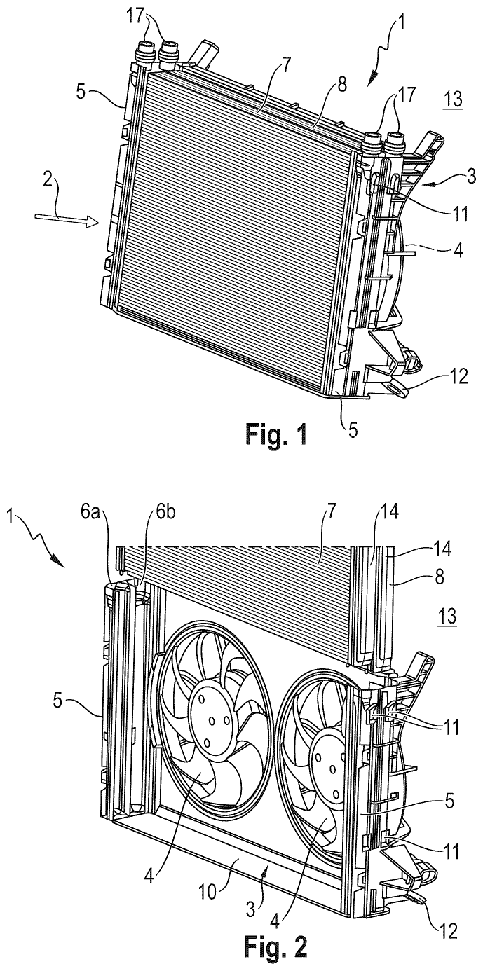

FIG. 1 shows a heat exchanger assembly according to the invention,

FIG. 2 shows the same as FIG. 1, with the heat exchangers partially pulled out,

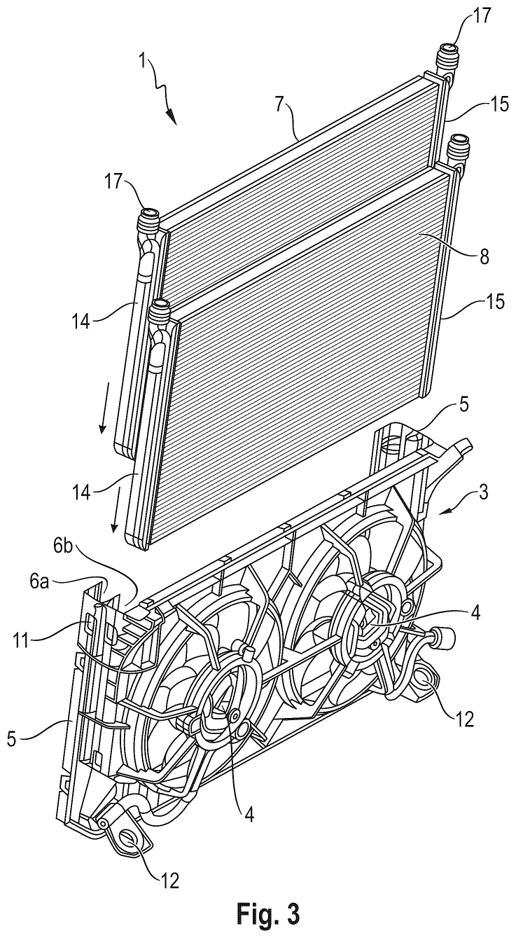

FIG. 3 shows the heat exchanger assembly according to the invention in an exploded view,

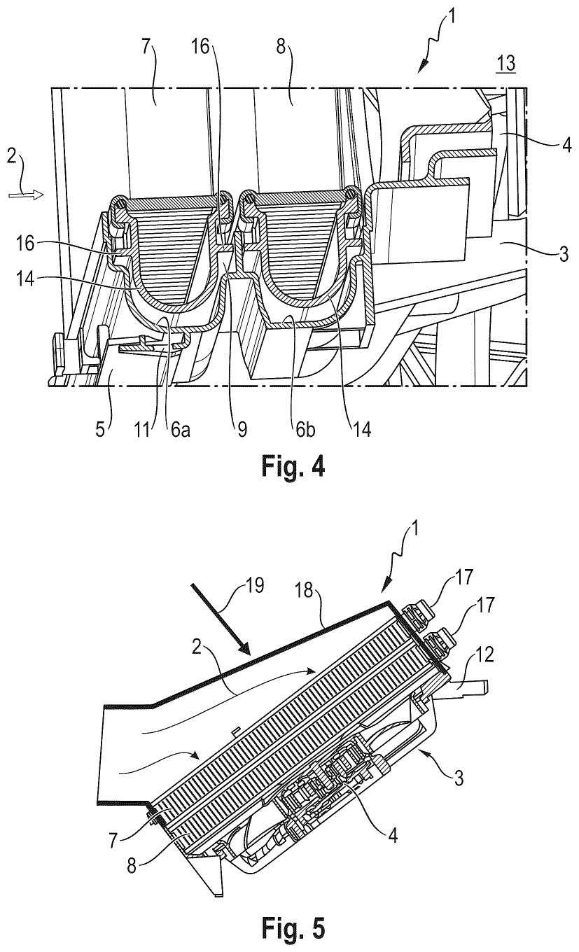

FIG. 4 shows a cross sectional view of grooves in the heat exchanger assembly according to the invention,

FIG. 5 shows a sectional view through the heat exchanger assembly according to the invention, with a diffusor.

The heat exchanger assembly 1 obtained with the invention shown in FIGS. 1-5, designed for transferring heat between two fluids, in particular a liquid and air 2, has a frame 3 that contains at least two adjacent fans 4 when assembled. The frame 3 has two parallel side pieces 5, each of which has at least one, in this case two, grooves 6a, 6b (see FIG. 4) for heat exchangers 7, 8, which are substantially parallel to one another, and through which the air flow 2 generated by the fans flows. These heat exchangers 7, 8 can be tilted ±10° to one another or the at least one fan 4, if the grooves 6a, 6b are aligned such. The heat exchangers 7, 8 can be slid into the grooves 6a, 6b to obtain a seal 9 (see FIG. 4), which at least minimizes air leakage through the grooves 6a, 6b, ideally eliminating such leakage. The heat exchangers 7, 8 are form-fit into these grooves 6a, 6b.

In general, “substantially parallel,” “substantially perpendicular”, “substantially horizontal or vertical” always allows for a deviation of ±10°.

The two heat exchangers 7, 8 can be connected to the frame 3 by simply inserting them from above into the grooves 6a, 6b, as shown in FIG. 3. Theoretically, they can also be inserted from below. This simplifies both assembly as well as replacement of the heat exchangers 7, 8 for maintenance or repairs. An advantage of this drawer-like system obtained with the invention is that installation space does not need to be reserved for the frame 3, because the heat exchangers 7, 8 can simply be removed from the grooves 6a, 6b from above. Because the heat exchangers 7, 8 are fit to the grooves 6a, 6b without forming a gap, not only is air leakage reduced, it is preferably eliminated, resulting a more efficient cooling obtained with the heat exchanger assembly 1.

Obviously, the heat exchanger assembly 1 can also have just one groove 6a and just one heat exchanger 7.

The frame 3 is made of injection molded plastic, preferably as a single piece, resulting in a high quality part that is also inexpensive to produce and does not further assembly.

The heat exchangers 7, 8 can be coolant coolers, condensers, or oil coolers, of which there are just two in FIGS. 1-4. There can actually be more of these heat exchangers 7, 8, e.g. an additional one in front of the first heat exchanger 7, in which case the frame 3 would also have additional grooves. The two side pieces 5 are connected at the bottom with a cross piece 10, which also prevents the heat exchangers 7, 8 from falling out of their grooves 6a, 6b. The two side pieces 5 could also be connected at the top by a cross piece, as long as it is possible to insert the heat exchangers 7, 8 into the grooves 6a, 6b from below.

There can also be a catch 11, formed integrally in at least one of the side pieces 5, which engages with a counterpart contour on the heat exchanger 7, 8 when it has been fully inserted into the grooves 6a, 6b, securing it in place, in particular vertically. The heat exchanger 7, 8 is thus secured in all three spatial directions by the frame 3, the grooves 6a, 6b, and the at least one catch 11.

The frame 3 can also have fastening contours 12 integrally formed thereon, with which the heat exchanger assembly 1 can be attached to the body of a motor vehicle 13, in particular a motor vehicle powered by an internal combustion engine, an electric vehicle, or a hybrid vehicle.

To minimize air leakage, the gap m formed in the grooves 6a, 6b when the heat exchanger 7, 8 is inserted therein is between 0.5 mm and 1.0 mm. Ideally, there is no gap, and heat exchanger 7, 8 fits precisely into the groves 6a, 6b, although a certain gap may be necessary to compensate for expansion caused by temperature fluctuations.

An additional sealing contour 16 can be formed on at least one heat exchanger 7, 8, or its reservoir 14, 15, which further improves the sealing obtained with the grooves 6a, 6b. The sealing contour 16 can be formed by an elastic sealing lip, or a stiff sealing fin, which is bonded to the frame 4, or formed as an integral part thereof.

The heat exchanger assembly 1 can be connected to a coolant circuit with nozzles 17, preferably at the tops of the heat exchangers 7, 8, such that they can be easily released for maintenance and repairs.

A diffusor 18 can be readily seen in FIG. 5, which is slid onto the heat exchanger assembly 1, specifically the at least one heat exchanger 7. The arrow 19 indicates the direction in which it is slid on. The diffusor 18 and the heat exchangers 7, 8 can therefore be removed, substantially upward, without the need for additional space at the sides thereof. An air flow 2 is supplied to the at least one heat exchanger 7 through the diffusor 18. The diffusor 18 can direct the air to the body of the motor vehicle and control the amount of air supplied to the heat exchangers 7, 8.

On the whole, the heat exchanger assembly 1 and motor vehicle 13 obtained with the invention result in a structurally simple, extremely efficient heat exchanger assembly 1 that is easy to install and maintain. The ease of maintenance and installation is due in particular to being able to readily insert the at least one heat exchanger 7, 8 into the grooves 6a, 6b from above, as well as to remove it therefrom. Because the frame 3 can be produced as a single injection molded part, production costs are also reduced.

The specification can be readily understood with reference to the following Numbered Paragraphs:
Numbered Paragraph 1. A heat exchanger assembly (1) for transferring heat between two fluids, in particular a liquid and air (2), characterized in that
   there is a frame (3) with at least one fan (4),
   the frame (3) has two parallel side pieces (5), each of which has a groove (6a) into which a heat exchanger (7) can be inserted,
   the heat exchanger (7) is substantially perpendicular to the air flow (2) passing through it, generated by the fan (4) in the assembled state,
   the heat exchanger (7) can be inserted into the groove (6a) such that a seal (9) is obtained, and air leakage through the groove (6a) is at least minimized.
Numbered Paragraph 2. The heat exchanger assembly (1) according to Numbered Paragraph 1, characterized in that the heat exchanger (7) and fan (4) are substantially parallel to one another in the assembled state.
Numbered Paragraph 3. The heat exchanger assembly (1) according to Numbered Paragraph 1 or 2, characterized in that
   the side pieces (5) each have at least two grooves (6a, 6b) for heat exchangers (7, 8),
   the at least two heat exchangers (7, 8) are substantially parallel to one another and substantially perpendicular to the air flow (2) passing through them, generated by the at least one fan (4),
   the heat exchangers (7, 8) can be inserted into the grooves (6a, 6b) such that a seal (9) is obtained, and air leakage through the grooves (6a, 6b) is at least minimized.
Numbered Paragraph 4. The heat exchanger assembly (1) according to Numbered Paragraph 1, 2, or 3, characterized in that the at least two heat exchangers (7, 8) can be inserted into the grooves (6a, 6b) from above or below.
Numbered Paragraph 5. The heat exchanger assembly (1) according to Numbered Paragraph 1, 2, 3, or 4, characterized in that the frame (3) is an injection molded part made of plastic, in particular a single piece of plastic.
Numbered Paragraph 6. The heat exchanger assembly (1) according to any of the preceding Numbered Paragraphs, characterized in that there is at least one catch (11) formed in at least one of the side pieces (5) as an integral part thereof, which engages with a counterpart contour formed on the heat exchanger (7, 8), thus securing it in place.
Numbered Paragraph 7. The heat exchanger assembly (1) according to any of the preceding Numbered Paragraphs, characterized in that fastening contours (12) are integrally formed on the frame (3) with which the heat exchanger assembly (1) can be attached to the body of a motor vehicle (13).
Numbered Paragraph 8. The heat exchanger assembly (1) according to any of the preceding Numbered Paragraphs, characterized in that at least one heat exchanger (7, 8) is form-fit into its grooves (6a, 6b), in particular without forming a gap, or with a gap m of 0.5 mm to 1.0 mm.
Numbered Paragraph 9. The heat exchanger assembly (1) according to any of the preceding Numbered Paragraphs, characterized in that there is a sealing contour (16) on the frame (3), which forms a seal for the grooves (6a, 6b).
Numbered Paragraph 10. The heat exchanger assembly (1) according to Numbered Paragraph 9, characterized in that the sealing contour (16) is an elastic sealing lip, or a sealing fin.
Numbered Paragraph 11. The heat exchanger assembly (1) according to any of the preceding Numbered Paragraphs, characterized in that at least one heat exchanger (7, 8) has reservoirs (14, 15) on opposite sides, which slide into the grooves (6a, 6b) formed in the frame (3).
Numbered Paragraph 12. The heat exchanger assembly (1) according to any of the preceding Numbered Paragraphs, characterized in that the heat exchanger assembly has a diffusor (18), which is slid onto the heat exchanger (7).
Numbered Paragraph 13. The heat exchanger assembly (1) according to any of the preceding Numbered Paragraphs, characterized in that at least one heat exchanger (7, 8) is a coolant cooler, condenser, or oil cooler.
Numbered Paragraph 14. A motor vehicle (13), in particular an electric vehicle, which has a heat exchanger assembly (1) according to at least one of the preceding Numbered Paragraphs.

1. A heat exchanger assembly for transferring heat between two fluids, in particular a liquid and air, comprising
a frame with at least one fan,
the frame has two parallel side pieces, each of which has a groove into which a heat exchanger can be inserted,
the heat exchanger is substantially perpendicular to the air flow passing through it, generated by the fan when the heat exchanger is inserted into the groove such that the heat exchanger is in an assembled state,
the heat exchanger is configured to be inserted into the groove such that a seal is obtained, and air leakage through the groove is at least minimized.

2. The heat exchanger assembly according to claim 1, wherein the heat exchanger and fan are substantially parallel to one another in the assembled state.

3. The heat exchanger assembly according to claim 1, wherein
the side pieces each have at least two grooves for at least two heat exchangers to be respectively inserted therein,
the at least two heat exchangers when inserted into the respective two grooves are substantially parallel to one another and substantially perpendicular to the air flow passing through them, generated by the at least one fan,
the heat exchangers are configured to be inserted into the grooves such that a seal is obtained, and air leakage through the grooves is at least minimized.

4. The heat exchanger assembly according to claim 3, wherein the at least two heat exchangers can be inserted into the grooves from above or below.

5. The heat exchanger assembly according to claim 1, wherein the frame is an injection molded part made of plastic.

6. The heat exchanger assembly according to claim 1, wherein there is at least one catch formed in at least one of the side pieces as an integral part thereof, which engages with a counterpart contour formed on the heat exchanger, thus securing the heat exchanger in place.

7. The heat exchanger assembly according to claim 1, wherein fastening contours are integrally formed on the frame with which the heat exchanger assembly can be attached to a body of a motor vehicle.

8. The heat exchanger assembly according to claim 1, wherein the heat exchanger is form-fit into the respective groove of the frame, without forming a gap.

9. The heat exchanger assembly according to claim 1, further comprising a sealing contour on the frame, which forms a seal for the grooves.

10. The heat exchanger assembly according to claim 9, wherein the sealing contour is one of an elastic sealing lip, or a sealing fin.

11. The heat exchanger assembly according to claim 1, wherein the heat exchanger comprises reservoirs on opposite sides thereof, wherein the reservoirs slide into the grooves formed in the frame.

12. The heat exchanger assembly according to claim 1, wherein the heat exchanger assembly has a diffusor, wherein the diffusor is configured to be slid onto the heat exchanger.

13. The heat exchanger assembly according to claim 1, wherein the heat exchanger is one of a coolant cooler, condenser, or oil cooler.

14. A motor vehicle, in particular an electric vehicle, which has a heat exchanger assembly according to claim 1.

15. The heat exchanger assembly of claim 5, wherein the frame is made of a single piece of plastic.

16. The heat exchanger assembly according to claim 1, wherein the heat exchanger is form-fit into the respective groove of the frame with a gap of 0.5 mm to 1.0 mm
